(19) United States
(12) Patent Application Publication
(10) Pub. No.: US 2007/0109222 A1
(43) Pub. Date: May 17, 2007

(54) Plasma display device and driving method thereof

(76) Inventor: Chee-Young Yoon, Yongin-si (KR)

Correspondence Address: CHRISTIE, PARKER & HALE, LLP, PO BOX 7068, PASADENA, CA, 91109-7068, US

(21) Appl. No.: 11/544,078

(22) Filed: Oct. 5, 2006

(30) Foreign Application Priority Data
Nov. 15, 2005 (KR) 10-2005-0109018

(51) Int. Cl. G09G 3/28

(52) U.S. Cl. 345/63

(57) ABSTRACT

A plasma display device and a driving method thereof, the plasma display device driven by dividing a plurality of scan electrodes into a plurality of groups. In one embodiment, to compensate for a weak discharge that may be generated when a temperature of the plasma display device is relatively high, an amount of lost wall charges is compensated by increasing a width of a sustain discharge pulse applied during a sustain period between address periods of the respective groups and/or by increasing a voltage level thereof. In one embodiment, the sustain discharge pulse width and/or the voltage level increases as an automatic power control level for one frame increases.

### CROSS-REFERENCE TO RELATED APPLICATION

This application claims priority to and the benefit of Korean Patent Application No. 10-2005-0109018, filed on Nov. 15, 2005 in the Korean Intellectual Property Office, the entire content of which is incorporated herein by reference.

### BACKGROUND OF THE INVENTION

1. Field of the Invention

The present invention is related to a plasma display device having a plasma display panel (PDP), and a driving method thereof.

2. Description of the Related Art

A plasma display device is a flat panel display that uses plasma generated by a gas discharge to display characters or images. It includes, depending on its size, a plasma display panel (PDP), wherein tens to millions of discharge cells (hereinafter, also referred to as cells) are arranged in a matrix format.

According to a driving method of a PDP, a frame is divided into a plurality of subfields having respective brightness weight values, and the subfields are time-divisionally controlled to thus represent gray levels. Each subfield includes a reset period, an address period, and a sustain period.

The reset period is for initializing each discharge cell so as to facilitate an addressing operation on the discharge cell, and the address period is for selecting turn-on cells (or on-cells), which are cells that should be turned on to display the intended image. That is, in the address period, a scan pulse (or signal) is sequentially applied to a plurality of scan electrodes, and an address pulse (or signal) is applied to an address electrode.

Here, an address discharge is generated in a cell to which the scan pulse and the address pulse are concurrently applied. In the sustain period, a sustain discharge pulse (or signal) alternately (or repeatedly and alternately) having a high level voltage and a low level voltage is applied to a scan electrode and a sustain electrode. Here, a sustain pulse phase applied to the scan electrode is opposite to a sustain pulse phase applied to the sustain electrode.

FIG. 1 shows a conventional method for expressing gray levels in a conventional PDP.

As shown in FIG. 1, a sustain discharge operation is concurrently applied to all the discharge cells during the sustain period after an addressing operation is sequentially applied to the scan electrode lines from the first scan electrode line Y1 to the last scan electrode line Yn.

According to the driving method of FIG. 1, when an addressing operation is applied to a scan electrode line, a sustain discharge operation is performed in the scan electrode line after the addressing operation is applied to the last scan electrode line. Therefore, a time gap between an addressing operation and a sustain discharge operation in a cell may be long enough to cause an unstable sustain discharge operation.

### SUMMARY OF THE INVENTION

An aspect of the present invention provides a plasma display device that can reduce a time gap between an addressing operation and a sustain discharge operation.

Another aspect of the present invention provides a driving method for driving a plasma display device that can reduce a time gap between an addressing operation and a sustain discharge operation.

In an embodiment of the present invention, a driving method for driving a plasma display device including a plurality of first electrodes and a plurality of second electrodes, wherein the plurality of second electrodes are divided into a plurality of groups that include a first group and a second group, is provided. The driving method includes: in at least one subfield including a plurality of address periods and a plurality of sustain periods, the address periods having at least one address period corresponding to the first group and at least one address period corresponding to the second group, and the sustain periods having at least one sustain period corresponding to the first group and at least one sustain period corresponding to the second group, selecting cells to be displayed from among cells of the first group and the second group in the at least one address period of the first group and the at least one address period of the second group; and determining a first pulse width of at least one first sustain discharge pulse in accordance with an automatic power control (APC) level, the at least one first sustain discharge pulse being applied during a first sustain period of the plurality of sustain periods, the first sustain period being between the at least one address period of the first group and the at least one address period of the second group.

In another embodiment of the present invention, a plasma display device is provided. The plasma display device includes a plasma display panel (PDP) and a controller. The PDP includes a plurality of first electrodes and a plurality of second electrodes. The controller generates a control signal for driving the PDP, and it determines an automatic power control (APC) level through input video signals. The plurality of second electrodes are divided into a plurality of groups that include a first group and a second group. The controller, in at least one subfield including a plurality of address periods and a plurality of sustain periods, the address periods having at least one address period corresponding to the first group and at least one address period corresponding to the second group, and the sustain periods having at least one sustain period corresponding to the first group and at least one sustain period corresponding to the second group, selects cells to be displayed from among cells of the first group and the second group during the at least one address period of the first group and the at least one address period of the second group, and determines a first pulse width of at least one first sustain discharge pulse in accordance with the APC level, the at least one first sustain discharge pulse being applied during a first sustain period of the plurality of sustain periods, the first sustain period being between the at least one address period of the first group and the at least one address period of the second group.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 shows a conventional method for expressing gray levels in a plasma display panel (PDP).

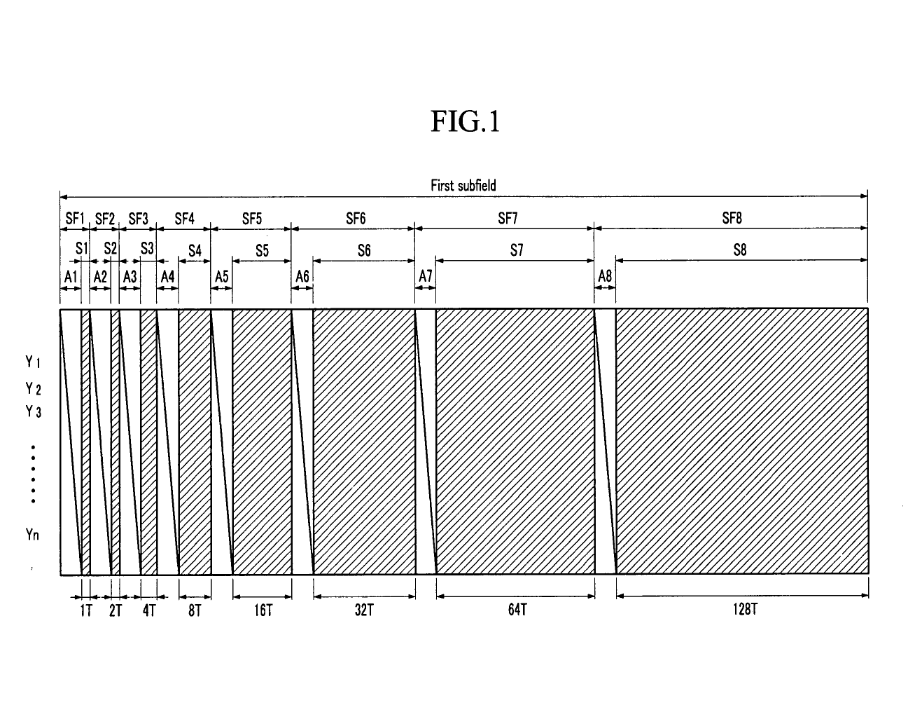

FIG. 2 is a schematic view of a plasma display device according to an exemplary embodiment of the present invention.

FIG. 3 shows a method for driving a plasma display device that divides scan electrodes into a plurality of groups (e.g., n groups) and drives a plurality of subfields divided from one frame for each of the groups.

FIG. 4 illustrates an example of dividing scan electrode of a plasma display panel (PDP) into four groups according to an exemplary embodiment of the present invention.

FIG. 5 shows a driving waveform diagram of a plasma display device according to a first exemplary embodiment of the present invention.

FIG. 6A and FIG. 6B show a wall charge distribution state in accordance with application of a driving waveform shown in FIG. 5.

FIG. 7 shows a process of a controller for application of a driving waveform shown in FIG. 5.

FIG. 8 shows a driving waveform diagram of a plasma display device according to a second exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Wall charges described in the following description refer to charges formed and accumulated on a wall (e.g., a dielectric layer) close to an electrode of a discharge cell. Here, the wall charges may be described as being “formed” or “accumulated” on the electrode, even though the wall charges may not actually touch the electrodes. Further, a wall voltage refers to a potential difference formed on the wall of the discharge cell by the wall charges.

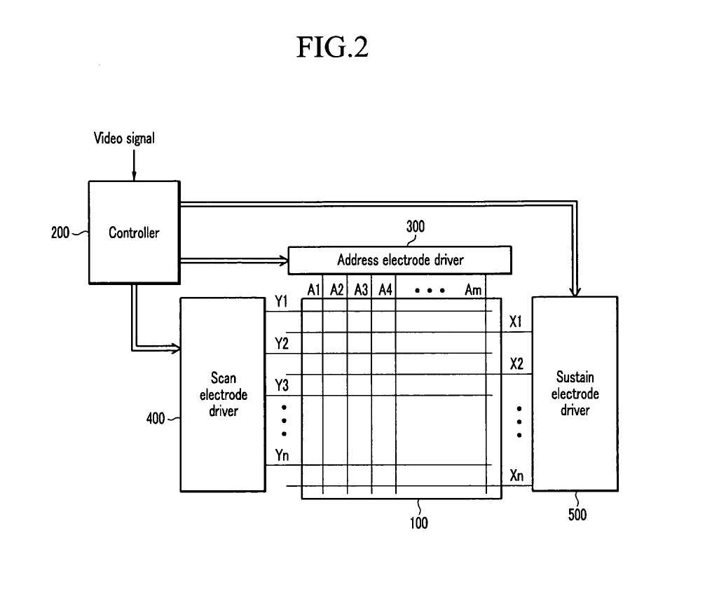

A plasma display device according to an exemplary embodiment of the present invention will be described with reference to FIG. 2.

As shown in FIG. 2, the plasma display device includes a plasma display panel (PDP) 100, a controller 200, an address driver 300, a scan electrode driver 400, and a sustain electrode driver 500. The PDP 100 includes a plurality of address electrodes A1 to Am extending in a column direction, and a plurality of sustain electrodes X1 to Xn and a plurality of scan electrodes Y1 to Yn extending in a row direction. The plurality of scan electrodes Y1 to Yn and the plurality of sustain electrodes X1 to Xn are arranged as pairs, respectively. Discharge cells are formed by the pairs of scan and sustain electrodes that cross the address electrodes.

The controller 200 receives external video signals and generates an address electrode driving control signal, a sustain electrode driving control signal, and a scan electrode driving control signal. Also, the controller 200 divides a frame into a plurality of subfields, wherein each of the subfields includes a reset period, an address period, and a sustain period in a temporal manner. After receiving the address electrode driving control signal from the controller 200, the address electrode driver 300 applies a display data signal for selecting discharge cells to be turned on (turn-on cells or on-cells) to the respective address electrodes.

The scan electrode driver 400 applies a driving voltage to the scan electrodes after receiving the scan electrode driving control signal from the controller 200. The sustain electrode driver 500 applies the driving voltage to the sustain electrodes after receiving the sustain electrode driving control signal from the controller 200.

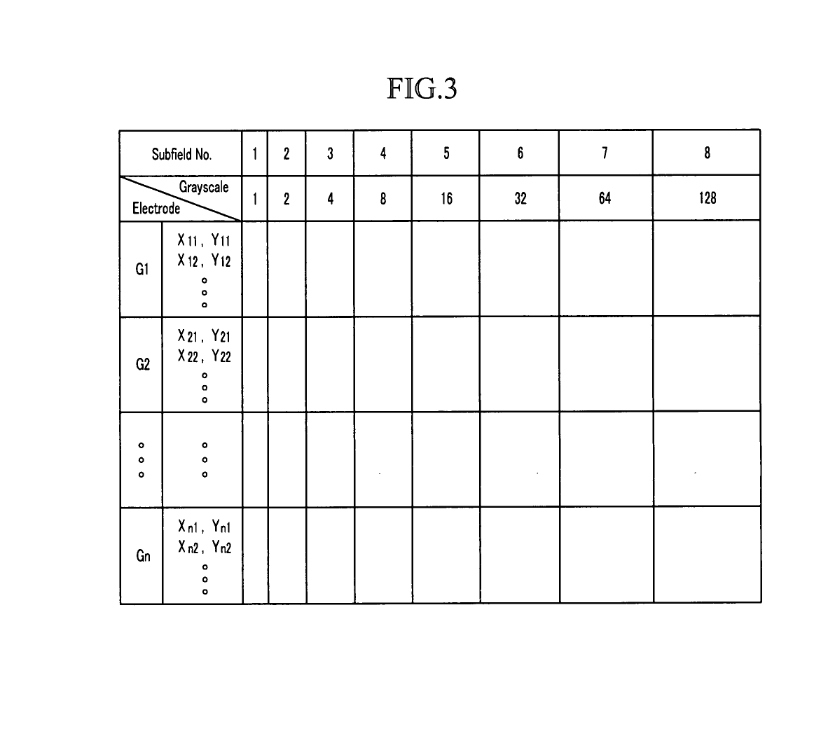

A method for driving a plasma display device according to an embodiment of the present invention will be described with reference to FIG. 3 to FIG. 5.

FIG. 3 is a block diagram showing a driving method of a PDP, in which scan electrode lines are divided into a plurality of groups (e.g., n groups) and one frame is divided into a plurality of subfields for the respective groups. Each of the groups expresses gray levels by a combination of eight subfields.

The scan electrode lines may be divided into a number (or predetermined number) of groups according to a physical arrangement order thereof. For example, when the PDP includes 800 scan electrode lines divided into 8 groups, the first group may include the first to 100^{th} scan electrode lines, and the second group may include the 101^{st} to 200^{th} scan electrode lines.

When dividing the scan electrode lines into a plurality of groups, each group needs not be formed of consecutive scan electrode lines. For example, each group may include scan electrode lines that are spaced apart by an interval (or a predetermined interval). Hence, the first group may include the first, ninth, seventeenth, . . . and (8K+1)th scan electrode lines, and the second group may include the second, tenth, eighteenth, . . . and (8K+2)th scan electrode lines. Additionally, the groups may be formed in any suitable manner, e.g., in a substantially random manner.

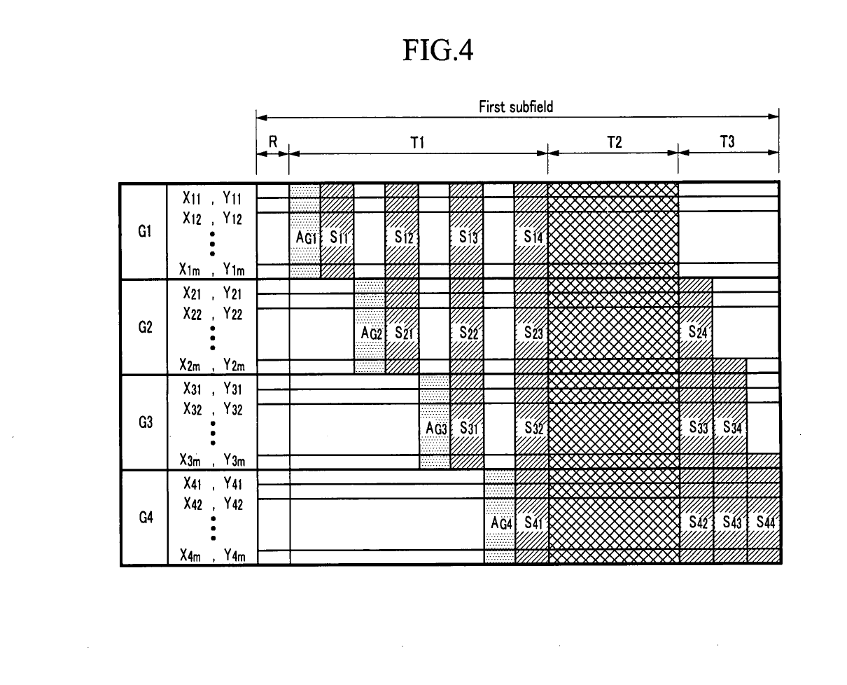

FIG. 4 is a block diagram showing an example in which scan electrode lines are divided into four groups in a PDP. One subfield may be expressed by a reset period R, an address/sustain combination period T1, a common sustain period T2, and a brightness correction period T3.

The reset period R is a period to initialize the wall charge state of each cell in the PDP by applying a reset pulse (signal) to all scan electrode line groups.

In the address/sustain combination period T1, an addressing operation AG1 is sequentially applied from a first scan electrode line Y11 to a last scan electrode line Y1m of a first group G1. After finishing the addressing operation AG1 on all the cells in the first group G1, at least two sustain pulses may be applied to the scan electrode lines of the first group G1 to perform a first sustain discharge operation S11.

After finishing the first sustain discharge operation S11 of the first group G1, an addressing operation AG2 is applied to each cell of a second group G2 of scan electrode lines.

When the addressing operation AG2 is finished, that is, after finishing the addressing operation on all the scan electrode lines of the second group G2, a first sustain period S21 is applied to the second group G2. In this case, a second sustain period S12 is applied to the first group G1 to which the first sustain period S11 has already been applied. When the desired gray levels has been expressed in the first sustain period S11 of the first group G1, the second sustain period S12 may not be applied to the first group G1. A pause state may be maintained for those cells to which an address period has not been applied.

When the first sustain period S21 of the second group G2 is finished, an address period AG3 and a first sustain period S31 are applied to a third group G3 of scan electrode lines in the above-noted manner. In this case, while the first sustain period S31 is applied to the third group G3, a second sustain period S22 may be applied to cells of the second group G2 and a third sustain period S13 may be applied to cells of the first group G1 to which previous sustain periods have already been applied. When the desired gray level has been expressed by the second sustain period S11 of the first group G1 and the first sustain period S21 of the second group G2, the further sustain periods S13 and S22 may not be applied.

Finally, when the first sustain period S31 ends, an address period AG4 and a first sustain period S41 are applied to a fourth group G4 of scan electrode lines in the above-noted manner. In this case, while the first sustain period S41 is applied to the fourth group G4, a second sustain period S32 may be applied to cells of the third group G3, a third sustain period S23 may be applied to cells of the second group G2, and a fourth sustain period S14 may be applied to cells of the first group G1, to which previous sustain periods have already been applied.

Referring to FIG. 4, while one sustain period is applied to cells of one group of scan electrode lines, further sustain periods may be applied to cells to which previous sustain periods have already been applied. In this case, assuming that the same number of sustain pulses are applied, and that the same brightness is realized during a unit of sustain period, the brightness of the first group G1 may be n times that of the nth group Gn. Likewise, the brightness of the second group G2 may be n−1 times that of the nth group Gn and the brightness of the (n−1)th group Gn−1 may be 2 times that of the nth group Gn. As such, further sustain periods may be applied in order to correct such brightness difference of the respective groups. Accordingly, in one embodiment as shown in FIG. 4, a brightness correction period T3 may be applied.

The brightness correction period T3 is designed to correct the respective groups' brightness difference such that cells have a uniform gray level for the respective groups. To this end, sustain discharges are selectively applied to the respective groups in the brightness correction period T3.

Also, a common sustain period T2 may be applied. The common sustain period T2 is a period in which a common sustain pulse is applied to all cells. Also, the common sustain period T2 may be applied when the gray levels specification allocated for the respective subfields is not sufficiently expressed by the address/sustain combination period T1, or the address/sustain combination period T1 and the brightness correction period T3. As shown in FIG. 4, the common sustain period T2 may be applied after the address/sustain combination period T1 and before the brightness correction period T3. Alternatively, the common sustain period T2 may be applied after the brightness correction period T3.

Furthermore, the common sustain period T2 may be variably applied so as to have an appropriate size according to a weight value of a subfield.

Also, in one embodiment, a subfield may be realized only in the address/sustain combination period T1.

As such, in view of the forgoing, after finishing the addressing operation and the sustain discharge operation on one group, the addressing operation and the sustain discharge operation are performed (sequentially performed) on other groups. That is, for example, the address and sustain periods may be applied (or sequentially applied) from the first group G1 to the fourth group G4 as shown in FIG. 4.

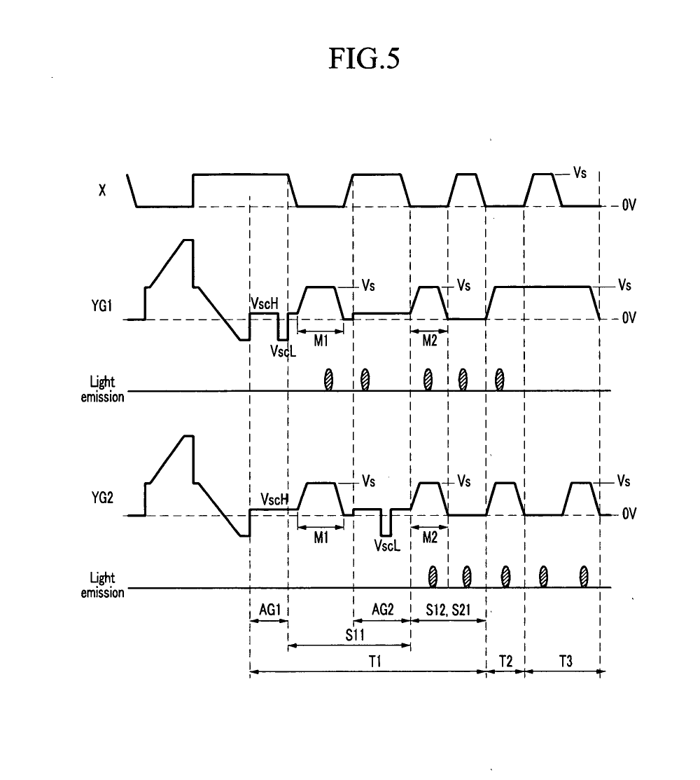

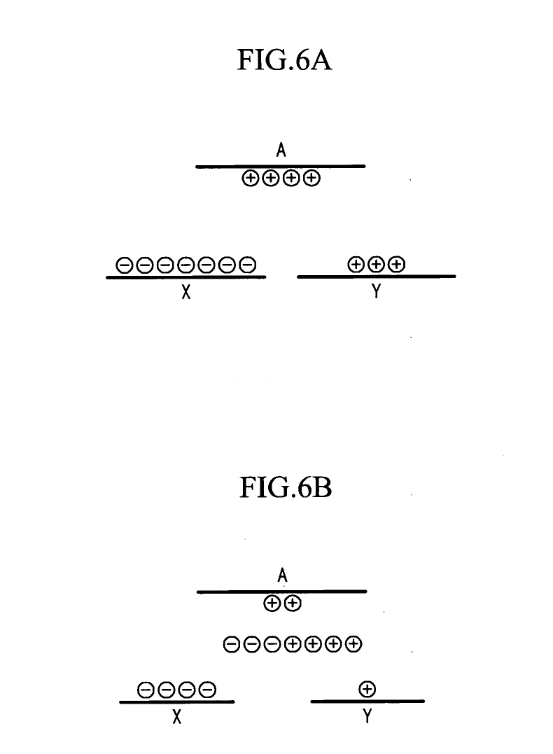

FIG. 5 is a driving waveform diagram of a plasma display device according to a first exemplary embodiment of the present invention, wherein the driving method of FIG. 4 is applied to scan electrodes, which are divided into two scan electrode groups YG1 and YG2, and a sustain electrode X. In addition, FIG. 6A and FIG. 6B illustrate a wall charge distribution state according to application of a driving waveform of FIG. 5.

A reset period R is designed to initialize the wall charge state of each cell by applying a reset waveform to the scan electrode lines of the first and the second groups YG1 and YG2.

In the address/sustain combination period T1, an address period AG1 and a sustain period S11 are first applied to the first group YG1. When the sustain period S11 ends, an address period AG2 is applied to the second group YG2. A second sustain period A12 is then applied to the first group YG1, while a first sustain period S21 is simultaneously (or concurrently) applied to the second group YG2.

Also, the address period AG1 of the address/sustain combination period T1 is applied to the scan electrodes of the first group YG1. In the address period AG1, a scan pulse (or signal) that has a voltage of VscL is sequentially applied to select the scan electrodes of the first group YG1, while the second electrodes of the second group YG2 are biased at a voltage of VscH. Though not shown, an address voltage is applied to the address electrodes so as to address (i.e., select, turn on) desired cells among cells defined by the scan electrodes to which the scan pulse is applied. Consequently, an address discharge is generated by the voltage difference of the address voltage and the voltage VscL and by a wall voltage formed by the wall charges on the address and scan electrodes, and accordingly a wall voltage is formed between the scan and sustain electrodes.

In the sustain period S11 of the address/sustain combination period T1, a sustain discharge pulse (signal) is alternately applied to the scan electrodes of the first and second group YG1 and YG2 and the sustain electrodes X. In FIG. 5, it is illustrated that a sustain pulse (signal) is applied once to the scan electrodes of the first and second groups YG1 and YG2 and the sustain electrode X. The sustain pulse may have a high level voltage (Vs voltage of FIG. 4) and a low level voltage (0V or VscH voltage of FIG. 4). The voltage of Vs or Vs-VscH, along with the wall voltage, generates a sustain discharge.

Here, in the sustain period S11, when the voltage Vs is applied to the scan electrodes of the first and second groups YG1 and YG2 and 0V is applied to the sustain electrodes X, a positive (or negative) wall voltage formed by the address discharge between the scan electrodes of the first and second groups YG1 and YG2 and the address electrodes, together with a voltage difference Vs between the scan electrodes of the first group YG1 and the sustain electrodes X, generates a sustain discharge.

As a result, the negative (or positive) wall voltage is formed between the scan electrodes and the sustain electrodes X. In the sustain period S11 of the address/sustain combination period T1, although the sustain pulse is applied to the scan electrodes of the second group YG2, the wall voltage is not formed between the scan electrodes YG2 and the sustain electrodes X. Hence, the sustain discharge is not generated between the scan electrodes YG2 and the sustain electrodes X. After finishing the address period AG1 and the sustain period S11 on the scan electrodes of the first group YG1, the address period AG2 may be applied to the scan electrodes of the second group YG2.

In the address period AG2 of the address/sustain combination period T1, the scan pulse (or signal), which has the voltage of VscL, is sequentially applied to select the scan electrodes of the second group YG2, while the scan electrodes of the first group YG1 and the unselected scan electrodes of the second group YG2 are biased at the voltage of VscH.

As noted above, an address voltage is applied to the address electrodes so as to address (i.e., turn on) desired cells among cells defined by the scan electrode line to which the scan pulse is applied. In FIG. 5, it is illustrated that the sustain period S11 may overlap the address period AG2. However, these two periods S11 and AG2 may alternatively be separate (or not overlap).

In the sustain periods S21 and S12 of the address/sustain combination period T1, the sustain pulse, which alternately has a voltage of Vs or 0V, is applied to the scan electrodes of the first and second groups YG1 and YG2. Consequently, sustain discharge is generated in the cells of the second group YG2 that were selected during the address period AG2 and the cells of the first group YG1 that were selected during the address period AG1. That is, in the address/sustain combination period T1, the sustain period S21 is applied to the second group YG2, while the second sustain period S12 is simultaneously (or currently) applied to the first group YG1.

In the common sustain period T2, the sustain pulse is alternately applied to the scan electrodes of the first and second groups YG1 and YG2 and the sustain electrodes X so that a common sustain discharge is generated in the scan electrodes of the first and second groups YG1 and YG2.

In the brightness correction period T3, further sustain periods are applied to the second group YG2 such that the selected cells of the first group YG1 and the second group YG2 may have substantially the same brightness. That is, in the brightness correction period T3, sustain discharge is generated only in the selected cells of the second group YG2. Therefore, sustain discharge is not generated in the selected cells of the first group YG1 in the brightness correction period T3.

Here, when the sustain pulse, which has the voltage of Vs, is applied to the sustain electrodes X, the voltage of Vs is applied to the scan electrodes of the first group YG1 and a ground voltage 0V is applied to the scan electrodes of the second group YG2. As a result, a discharge is not generated in the cells of the first group YG1 since a voltage difference between the scan electrodes of the first group YG1 and the sustain electrodes X is 0V, but a sustain discharge is generated in the selected cells of the second group YG2.

Thereafter, 0V is applied to the sustain electrode X and the voltage of Vs is applied to the scan electrodes of the first group YG1 and the scan electrodes of the second group YG2. As a result, since the previous sustain discharge is not generated and the reverse polarity of wall voltage is formed, the sustain discharge is still not generated in cells of the first group YG and is only generated in cells of the second group YG2.

In this manner, the cells of the first group YG1 have the same brightness as that of the cells of the second group YG2 by restraining the number of sustain discharges of the second group YG2 to be the same as the number of sustain discharges of the first group YG1.

Accordingly, in the subfield of FIG. 5, discharges are generated five times (to generate five light emissions) in the selected cells of the first and second groups YG1 and YG2, respectively.

When the temperature of the PDP 100 or the ambient temperature of the PDP 100 is high, a low discharge may be generated during application of an address voltage since formation conditions of a MgO layer that covers the scan electrode Y and the sustain electrode X are highly sensitive to the temperature of the PDP 100. Particularly, when a scan pulse is later applied to the scan electrode, wall charges accumulated on the scan electrode Y and the sustain electrode X are lost into a space between the scan electrode Y and the sustain electrode X so that an address discharge may not be appropriately generated.

The wall charge state of FIG. 5 becomes the wall charge stage of FIG. 6A after the reset period. That is, as shown in FIG. 6A, negative (−) wall charges (or predetermined negative (−) wall changes) are formed on the scan electrodes of the first and second groups YG1 and YG2 and the sustain electrodes X, and positive (+) wall charges (or predetermined positive (+) wall charges) are formed on the address electrodes A after the reset period and before application of the scan pulse.

After the application of the address period AG1 and the application of the sustain period S11 to the scan electrodes of the first group YG1 are finished, the address period AG2 is applied to the scan electrodes of the second group YG2. Therefore, while the addressing operation and the sustain discharge are applied to the scan electrodes of the second group YG2, a significant amount of wall charges are lost into a space between the electrodes and thus the amount of wall charges that have been accumulated on the electrodes before application of the voltage of VscL in the address period AG2 is significantly reduced as shown in FIG. 6B.

In particular, when the temperature of the PDP 100 or the ambient temperature is relatively high before application of the scan pulse, the significant amount of wall charges is lost into the space between the electrodes. In this case, scan electrodes that are later applied with the scan pulse are initialized to a state of having a relatively small amount of positive (+) wall charges and negative (−) wall charges respectively formed thereon.

Therefore, in one embodiment, the loss of negative (−) wall charges is compensated by setting a pulse width M1 of the voltage of Vs which is applied to the scan electrodes of the first and second groups YG1 and YG2 in the sustain period S11 of the address/sustain combination period T1 to be greater (wider) than a pulse width M2 of a typical sustain discharge in the common sustain period T2 or the brightness correction period T3, since the negative (−) wall charges are accumulated on the scan electrodes of the first and second groups YG1 and YG2 when the pulse width M1 is greater (wider) than the pulse width M2, as shown in FIG. 5.

That is, time for the negative (−) wall charges that have been lost into the space between the scan and sustain electrodes to be accumulated on the scan electrodes (or negative (−) wall charge accumulation time) is extended by increasing the pulse width M1 of the voltage of Vs in the sustain period S11. Hence, the scan electrodes of the second group YG2 are initialized at the wall charge state of FIG. 6B before the application of the scan pulse in the address period AG2 such that a more stable address discharge can be generated. That is, an inefficient accumulation of the wall charges in the address period due to a high temperature is compensated by the above extension of the accumulation time.

However, since time assigned for one frame is limited, the pulse width M1 of the voltage of Vs which is applied to the scan electrodes of the first and second groups YG1 and YG2 during the sustain period S11 of the address/sustain combination period T1 cannot be extended too much. Therefore, the pulse width M1 of the voltage of Vs is determined in accordance with the time assigned for the common sustain period T2 or the brightness correction period T3.

That is, the time assigned to the common sustain period T2 or the brightness correction period T3 is extended as the number of sustain discharge pulses applied to the common sustain period T2 or the brightness correction period T3 increases, and accordingly, the pulse width M1 of the Vs voltage applied during the sustain period S11 of the address/sustain combination period T1 is reduced.

By contrast, the pulse width M1 of the Vs voltage applied during the sustain period S11 of the address/sustain combination period T1 is extended when the number of sustain discharge pulses decreases.

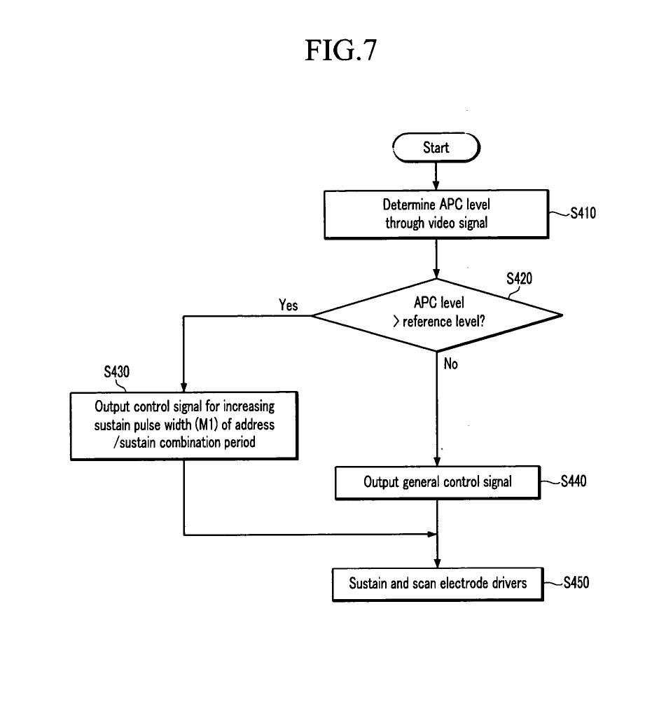

An operation of the controller 200 of the plasma display device according to the first exemplary embodiment of the present invention will now be described with reference to FIG. 7.

FIG. 7 shows an operation of the controller according to the first exemplary embodiment of the present invention.

As shown in FIG. 7, the controller 200 controls the pulse width M1 of the voltage Vs applied during the sustain period S11 of the address/sustain combination period T1 in accordance with an automatic power control (APC) level.

Here, the APC level in the present embodiment refers to the amount of power that is consumed for driving one frame when driving the plasma display device, and the amount of power consumption can be controlled by controlling the number of sustain discharge pulses in accordance with the APC level. In general, a screen load is minimized when an APC level is low, whereas the screen load is increased when the APC level is high so that the number of sustain discharge pulses is controlled to decrease.

Therefore, in all frames, the APC level increases as the number of cells that represent relatively high gray levels increases such that the number of maximum sustain discharge pulses; is controlled to decrease, whereas the APC level decreases as the number of cells that represent relatively low gray levels increases such that the number of maximum sustain discharge pulse is controlled to increase.

As shown in FIG. 7, the controller 200 calculates an average signal level from red (R), green (G), and blue (B) data included in input video signals.

Herein, an average signal level (ASL) for each frame is calculated by Equation 1.

$$ASL = {\sum }_{x = 1}^{N} {\sum }_{y = 1}^{M} \frac{{R}_{x , y} + {G}_{x , y} + {B}_{x , y}}{3 \times N \times M} \qquad [ Equation 1 ]$$

In Equation 1, R_{x,y}, G_{x,y}, and B_{x,y} respectively denote R, G, and B gray level values at (x, y), and N and M respectively denote a horizontal size and a vertical size of each frame.

First, the controller 200 determines an APC level required for driving the plasma display device based on the average signal level in step S410. Then, the controller 200 compares the determined APC level and a reference APC level (or a predetermined reference APC level) in step S420. At this time, since the number of sustain discharge pulses is reduced when the determined APC level is greater than the reference APC level, a control signal is output to control the sustain discharge pulse width of the address/sustain combination period to be increased as shown in FIG. 5, in step S430.

However, since the number of sustain discharge pulses is increased when the determined APC level is less than (or not greater than) the reference APC level, the controller 200 outputs a typical control signal in step S440 to control the sustain discharge pulse width of the address/sustain combination period to correspond to (or be substantially the same as) the width M2 as shown in FIG. 5 so that an occurrence of a discharge between the scan electrode Y and the sustain electrode X in the sustain period is controlled. Herein, the reference APC level corresponds to an APC level for a sustain pulse width of the address/sustain common period address period for reducing or preventing an occurrence of weak discharge in the address period, and the reference APC level can be experimentally obtained.

Therefore, in FIG. 5, the number of sustain discharge pulses decreases as the APC level increases, but the sustain pulse width M1 of the address/sustain combination period increases as the APC level increases, thereby further reducing or preventing the occurrence of a weak discharge.

By contrast, the number of sustain discharge pulses increases as the APC level decreases so that the sustain pulse width M1 of the address/sustain combination period is restricted to a width that can still reduce or prevent a weak discharge occurrence in the address period AG2.

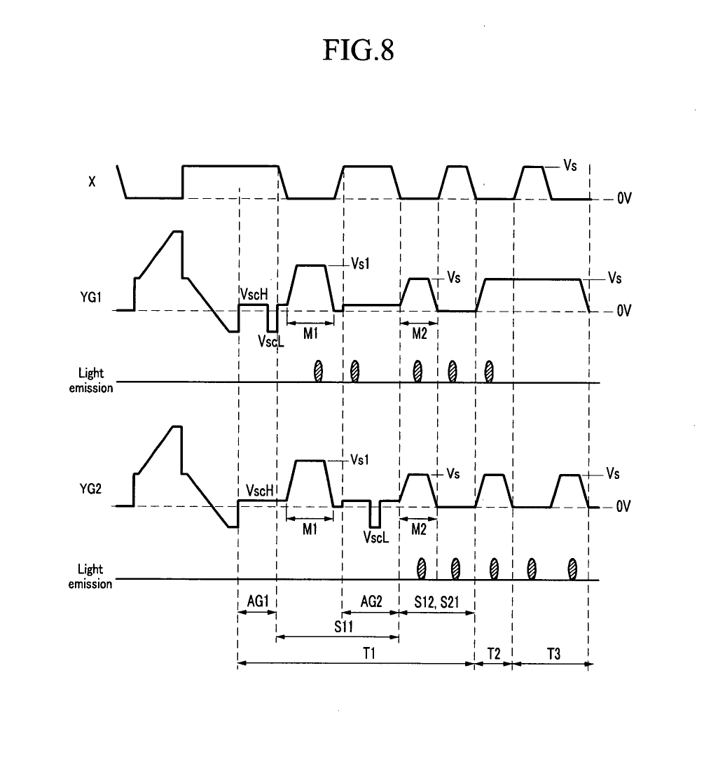

The weak discharge occurrence can be reduced or prevented by increasing the sustain pulse width M1 when the APC level is greater than the reference APC level according to the first exemplary embodiment of the present invention, but as shown in FIG. 8, it can also be prevented by increasing a voltage level of the sustain pulse M1 of the address/sustain combination period according to a driving waveform of a plasma display device in a second exemplary embodiment of the present invention.

As shown in FIG. 8, the second exemplary embodiment is substantially the same as the first exemplary embodiment of the present invention, except that the voltage level of the sustain pulse of the address/sustain combination period is increased to a voltage of Vs1, and therefore a further detailed description will not be provided again.

According to the above-described embodiments of the present invention, an occurrence of a weak discharge at a high temperature can be reduced or prevented by controlling a sustain pulse width or a voltage level of a address/sustain combination period according to an APC level in a plasma display device having a plurality of scan electrodes and driven by dividing the plurality of scan electrodes into a plurality groups.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A driving method for driving a plasma display device by a plurality of subfields divided from one frame, the plasma display device having a plurality of first electrodes and a plurality of second electrodes, the plurality of second electrodes being divided into a plurality of groups including a first group and a second group, the driving method comprising:
in at least one subfield including a plurality of address periods and a plurality of sustain periods, the address periods having at least one address period corresponding to the first group and at least one address period corresponding to the second group, and the sustain periods having at least one sustain period corresponding to the first group and at least one sustain period corresponding to the second group,
selecting cells to be displayed from among cells of the first group and the second group in the at least one address period of the first group and the at least one address period of the second group; and
determining a first pulse width of at least one first sustain discharge pulse in accordance with an automatic power control (APC) level, the at least one first sustain discharge pulse being applied during a first sustain period of the plurality of sustain periods, the first sustain period being between the at least one address period of the first group and the at least one address period of the second group.

2. The driving method of claim 1, further comprising alternately applying a second sustain discharge pulse having a second pulse width to the plurality of first electrodes and the plurality of second electrodes during a second sustain period of the plurality of sustain periods, the second sustain period being after the at least one address period of the second group.

3. The driving method of claim 2, wherein the first pulse width is wider than the second pulse width when the APC level is greater than a reference level.

4. The driving method of claim 2, wherein the first pulse width corresponds to the second pulse width when the APC level is not greater than a reference level.

5. The driving method of claim 2, wherein the first sustain discharge pulse has a higher voltage level than a voltage level of the second sustain discharge pulse.

6. The driving method of claim 2, wherein the first pulse width is wider when the APC level is greater than a first reference level and is narrower when the APC level is not greater than the first reference level.

7. The driving method of claim 2, wherein the second pulse width is not greater than the first pulse width.

8. The driving method of claim 2, wherein the second pulse width is less than the first pulse width.

9. The driving method of claim 1, wherein second sustain discharge pulses in a second sustain period of the plurality of sustain periods when the APC level is greater than a reference level are less in number than that of the second sustain pulses in the second sustain period when the APC level is less than the reference level.

10. The driving method of claim 9, further comprising alternately applying the second sustain discharge pulses having a second pulse width to the plurality of first electrodes and the plurality of second electrodes during the second sustain period, the second sustain period being after the at least one address period of the second group, and the second pulse width being not greater than the first pulse width.

11. A plasma display device comprising:
a plasma display panel (PDP) having a plurality of first electrodes and a plurality of second electrodes; and
a controller for generating a control signal for driving the PDP and for determining an automatic power control (APC) level through input video signals,
wherein the plurality of second electrodes are divided into a plurality of groups including a first group and a second group, and
the controller, in at least one subfield including a plurality of address periods and a plurality of sustain periods, the address periods having at least one address period corresponding to the first group and at least one address period corresponding to the second group, and the sustain periods having at least one sustain period corresponding to the first group and at least one sustain period corresponding to the second group:
selects cells to be displayed from among cells of the first group and the second group during the at least one address period of the first group and the at least one address period of the second group, and
determines a first pulse width of at least one first sustain discharge pulse in accordance with the APC level, the at least one first sustain discharge pulse being applied during a first sustain period of the plurality of sustain periods, the first sustain period being between the at least one address period of the first group and the at least one address period of the second group.

12. The plasma display device of claim 11, wherein a second sustain discharge pulse having a second pulse width is alternately applied to the plurality of first electrodes and the plurality of second electrodes during a second sustain period of the plurality of sustain periods, the second sustain period being after the at least one address period of the second group.

13. The plasma display device of claim 12, wherein the controller increases the first pulse width to be greater than the second pulse width when the APC level is greater than a reference level.

14. The plasma display device of claim 12, wherein the controller controls the first pulse width to be substantially the same as the second pulse width when the APC level is not greater than a reference level.

15. The plasma display device of claim 12, wherein the first pulse width is wider when the APC level is greater than a first reference level and is narrower when the APC level is not greater than the first reference level.

16. The plasma display device of claim 12, wherein the second pulse width is not greater than the first pulse width.

17. The plasma display device of claim 12, wherein the second pulse width is less than the first pulse width.

18. The plasma display device of claim 12, wherein the controller increases a voltage level of the first sustain discharge pulse to be greater than that of the second sustain discharge pulse.

19. The plasma display device of claim 11, wherein the controller controls a plurality of second sustain discharge pulses to be less in number in a second sustain period of the plurality of sustain periods when the APC level is greater than a reference level than that of the second sustain pulses in the second sustain period when the APC level is less than the reference level.

20. The plasma display device of claim 19, wherein the second sustain discharge pulses having a second pulse width are alternately applied to the plurality of first electrodes and the plurality of second electrodes during the second sustain period, the second sustain period being after the at least one address period of the second group, and the second pulse width being not greater than the first pulse width
